(19) United States
(12) Patent Application Publication
(10) Pub. No.: US 2007/0085382 A1
(43) Pub. Date: Apr. 19, 2007

(54) Post in a carrier structure of a motor vehicle in a spaceframe style

(76) Inventors: Thomas Floth, Duisburg (DE); Axel Gruneklee, Duisburg (DE); Bernhard Osburg, Duisburg (DE); Lothar Patberg, Aachen (DE); Stefan Schwarz, Lunen (DE)

Correspondence Address: PROSKAUER ROSE LLP;PATENT DEPARTMENT, 1585 BROADWAY, NEW YORK, NY, 10036-8299, US

(21) Appl. No.: 10/569,742

(22) PCT Filed: Aug. 9, 2004
(86) PCT No.: PCT/EP04/08894

§ 371 Date: Dec. 18, 2006

(30) Foreign Application Priority Data
Aug. 27, 2003 (DE) 103 39 809.0
Oct. 14, 2003 (DE) 103 47 556.7

(51) Int. Cl. B60K 37/00

(52) U.S. Cl. 296/203.01

(57) ABSTRACT

The invention relates to a carrier structure of a motor vehicle in a spaceframe style, said structure comprising a roof frame (1) provided with a longitudinal member (1a) and a cross member (1b), longitudinal members (2a, 2b) which are arranged on both sides at the level of the vehicle floor and consist of hollow profiled elements, and posts (3, 4, 5) in the form of hollow profiled elements, connecting the longitudinal members (1a, 1b) of the roof frame (1) to the longitudinal members (2a, 2b) on the side of the floor. The inventive carrier structure is characterised in that at least two opposing posts (3, 4, 5) of the member structure, especially the B, C or D posts, are embodied as double plates formed under internal high pressure and welded on the peripheral edge thereof. The peripheral edge forms flanges (3c, 5c) for door and/or window seals, and the respective ends of the posts (3, 4, 5) are embodied as connection regions (31, 51, 32, 52) adapted to the shape of the longitudinal members (2a, 2b) on the side of the floor and the longitudinal members (1a) of the roof frame (1), and used for connection to the same.

The invention relates to a carrier structure of a motor vehicle in a spaceframe style comprising a roof frame provided with a longitudinal member and a cross member, and longitudinal members made of hollow profiled elements arranged at both sides at the level of the vehicle floor, and with posts in the form of hollow profiled elements, which connect the longitudinal members of the roof frame with the floor-side longitudinal members.

Carrier structures for motor vehicles in spaceframe style exhibit a plurality of members and posts, which are embodied as hollow profiled elements. In the case of the posts, a variety of technologies are available to lend the hollow profile elements the particular shape desired. The embodiment of the posts as rolled profile elements has the advantage of relatively economical manufacture, whereby, thanks to the use of what are referred to as tailored strips, the material used can be adapted in respect of its thickness and quality to the user's specifications. In addition to this, flanges for seals can be integrated into the profile without great expenditure or effort. These advantages are, however, offset by the decisive disadvantage that no variable cross-sections are possible with the rolling technology. It follows from this that with modern motor vehicles the typical course of a post, such as the B, C, or D post, cannot be represented with a large cross-section, advantageous in respect of the crash properties of the vehicle, in the lower area, and with a slender cross-section above the window breast, desirable from design considerations.

The use of what are referred to as DAVEX profiled elements, which as hollow profiled elements consist of two opposed belts and two webs connecting the belts, likewise offers the advantage of economical manufacture of the posts. In addition, several flanges are provided from the outset, due to manufacturing constraints, to accommodate the seals. The disadvantage of a cross-section which is constant over the length is also, however, incurred with these profiled elements. Added to this is the fact that DAVEX profiled elements can only be manufactured with a minimum material thickness, which leads to an unacceptable weight of the post from the point of view of lightweight construction.

According to a further known manufacturing arrangement, a tubular initial profiled element can be formed by high internal pressure to manufacture the post. In this situation, it is indeed possible, to a limited extent, to form a cross-section which changes along the course of the post, but only at the expense of too high a consumption of material in the regions with small cross-section, for example in the area above the window breast. This superfluous material must then be concealed by inwardly-directed beading, but contributes to an overall excessively high weight of the post. More marked cross-section changes of the post in the region of the connection of the post to the members running in the longitudinal direction of the motor vehicle (node area) cannot be produced with a hollow profiled element by high internal pressure forming. Another disadvantage is that flanges for seals are to be provided on the hollow profiled elements for an additional process step. Finally, it is difficult, from the point of view of lightweight construction, to manufacture complex shaped connection regions on hollow profiled elements formed under high internal pressure.

Another disadvantage is that flanges for seals are to be provided on the hollow profiled elements in an additional process step. Finally, it is difficult to manufacture complex shaped connection regions on hollow profiled elements formed under high internal pressure.

The invention is therefore based on the object of creating a carrier structure of a motor vehicle in spaceframe style, which can be adapted to the shape specifications of the user, in particular in the region of the posts, without great expense of effort, and which is characterised by a high degree of rigidity and crash safety.

This object is resolved with a carrier structure of the type referred to in the preamble, according to the invention, in that at least two opposing posts of the carrier structure, in particular the B, C, or D posts, are formed from double plates formed by high internal pressure and welded at their circumferential edges, whereby the circumferential edges form flanges for door seals and/or window seals, and the respective ends of the posts are embodied as connection regions adapted to the shape of the floor-side longitudinal members and the longitudinal members of the roof frame for connection to the floor-side longitudinal members and the longitudinal members of the roof frame.

With the carrier structure according to the invention, the posts formed as double plates formed with high internal pressure exhibit great variability with regard to their shaping. This accordingly allows them to be manufactured easily in the specified shape without the need for a further forming step. In addition to this, the post ends embodied as connection regions can be easily adapted to the shape and relative position of the longitudinal member of the roof frame and the floor-side longitudinal member respectively. This accordingly allows for a secure connection of the post to the carrier structure by means of high-rigidity node structures, which makes a decisive contribution to the crash safety of the carrier structure as a whole.

With the circumferential edge of the double plates formed under high internal pressure to form a post, readily usable flanges for door and window seals are also provided. The flanges can serve as contact surfaces for a seal, but expediently they can also accommodate the seal itself.

Further improved crash safety of the carrier structure can be achieved if the two plates of the double plate arrangement are made of different materials. In this way, for example, the plates forming the outer side of the post can be made of a high-strength steel. It is likewise of advantage from crash and lightweight structure considerations if at least one of the two plates of the double plate arrangement consists of a tailored blank. By using tailored blanks the wall thickness and therefore the rigidity of the post can be strengthened in a specific manner in the areas particularly at risk in the event of a crash, while in the areas of less relevance in the event of a crash it is possible to save weight by having a reduced wall thickness.

With the carrier structure according to the invention it is possible for the posts to be formed with a cross-section which changes along their length, so that, as indicated in the preamble, the posts can exhibit a large cross-section in the lower region, particularly at risk in the event of a crash, and in the upper region, i.e. above the window breast, they can exhibit a cross-section selected as small corresponding to the design specifications.

According to one embodiment of the invention, provision is made for at least one of the post ends in each case to be splayed. Thanks to the splayed post ends, large-volume and therefore particularly rigid node structures can be created in the carrier structure according to the invention.

An advantageous means of connecting the posts to the longitudinally running profiled elements of the carrier structure consists of at least one of the post ends in each case being inserted into the floor-side longitudinal member or longitudinal member of the roof frame allocated to it, and being supported there on the opposing side surfaces of the individual longitudinal member, in particular at beads formed at that point. In this situation the inserted end of the post functions like a bulkhead plate and so increases the torsion rigidity of the longitudinal member in particular. By means of such an insertion solution, which is suitable in particular for the connection of the posts to floor-side longitudinal members, such as the floor sills, a highly rigid node structure is created, by means of which the carrier structure guarantees optimum protection for the occupants in the event of a side impact. In addition to this, the node structure can be designed in such a way that its crash behaviour equates to that of a crashbox; in other words, thanks to a defined type o f deformation, it contributes to the reduction of the forces taking effect in the event of an impact.

According to a further embodiment of the invention, provision is made for in each case at least one of the post ends to be cut to length. By appropriate cutting, flanges are created at these post ends, by means of which the post can be brought in contact with longitudinal members of the carrier structure and connected to them. This type of connection makes a particularly compact node structure possible, which is particularly well-suited for the connection of the upper column end to the longitudinal member of the roof frame and exhibits adequate rigidity. Expediently, at least one cut post end is in contact at the outer side and at least one further side of the floor-side longitudinal member or longitudinal member of the roof frame allocated to it. This prevents the risk of the post, in the event of a severe side impact, leading for example to the tearing of the weld seams or similar joint connections, being pressed at one end into the interior of the vehicle, which would lead to the occupants being injured. A particularly secure connection is attained if at least one cut post end surrounds the longitudinal member allocated to it in a U-shape.

The invention is described hereinafter in greater detail on the basis of drawings representing an embodiment example. The drawings show:

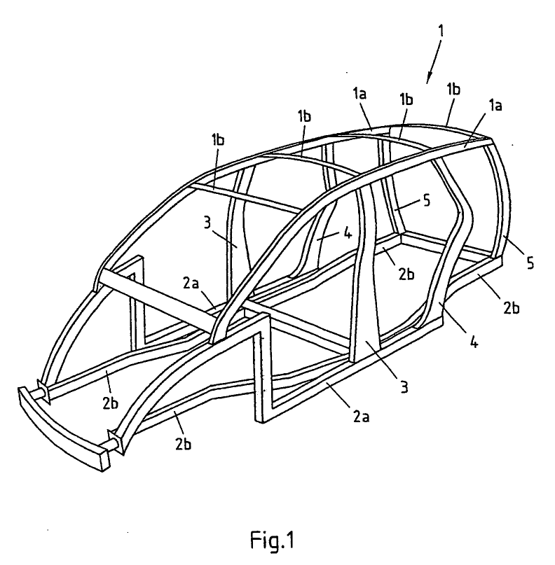

FIG. 1 A carrier structure of a motor vehicle in spaceframe style composed of hollow profiled elements, with a roof frame, floor-side longitudinal members, and posts connecting the roof frame to the longitudinal members,

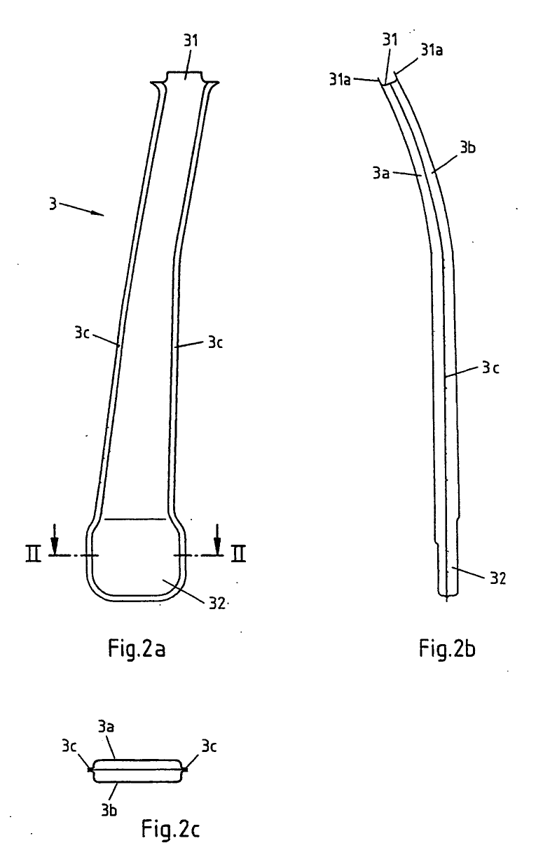

FIG. 2 a-c A B post of the carrier structure from FIG. 1 in a two-fold side view as well as in a sectional view according to the line II-II from FIG. 2a,

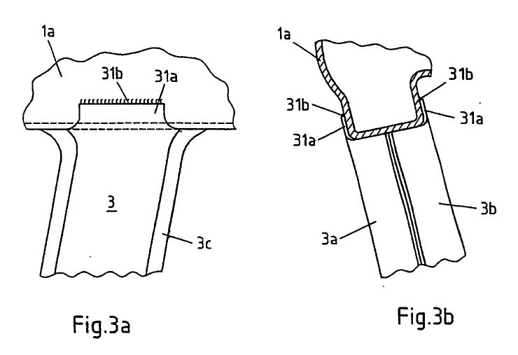

FIG. 3 a,b A node structure for connecting the B post from FIG. 2 to a longitudinal member of the roof frame of the carrier structure from FIG. 1 in a two-fold side view,

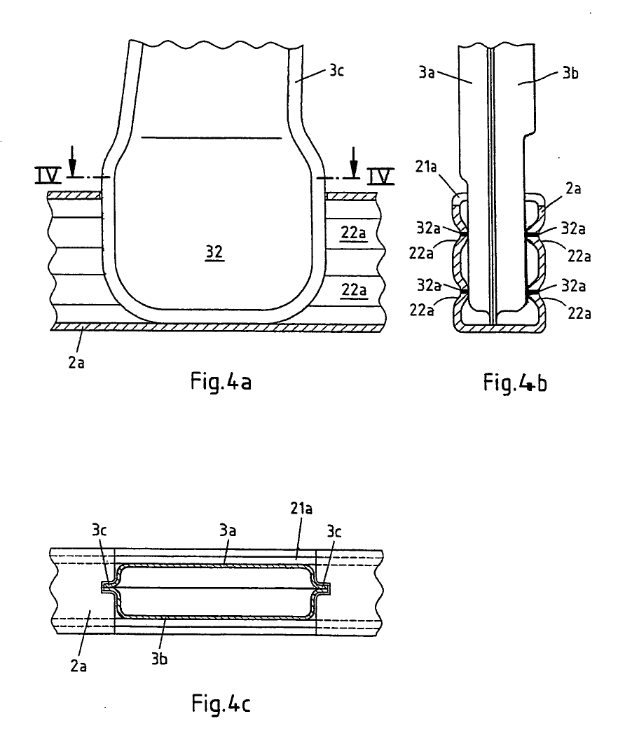

FIG. 4 a,b A node structure for the connection of the B post from FIG. 2 to a floor-side longitudinal member of the carrier structure from FIG. 1 in a two-fold view, as well as in a sectional view according to the line IV-IV from FIG. 4a,

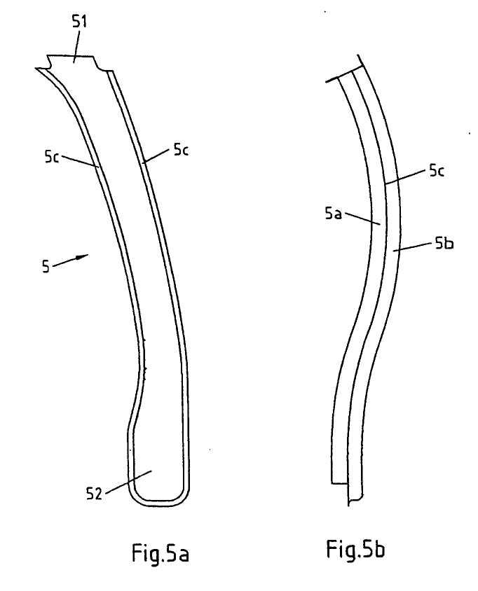

FIG. 5 a,b A D post from the carrier structure from FIG. 1 in a two-fold side view,

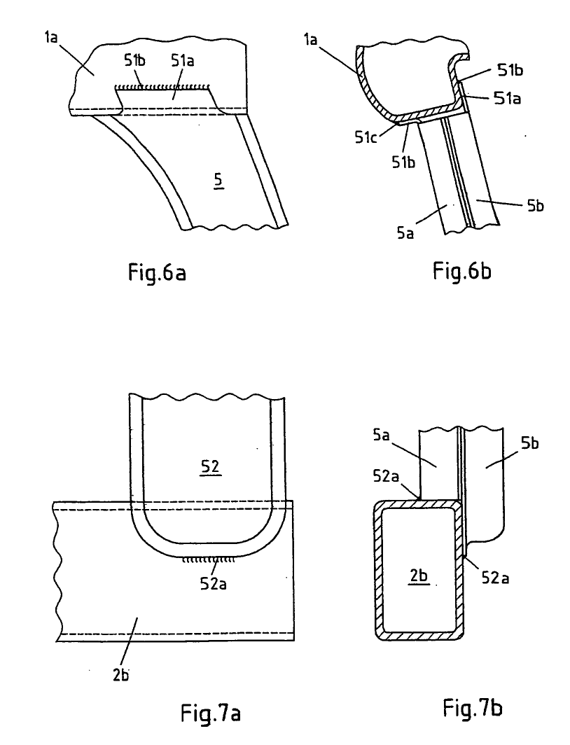

FIG. 6 a,b A node structure for the connection of the D post from FIG. 5 to a longitudinal member of the roof frame from FIG. 1 in a two-fold side view, and

FIG. 7 a,b A node structure for the connection of the D post from FIG. 5 to a floor-side longitudinal member of the carrier structure from FIG. 1 in a two-fold side view.

The carrier structure composed of hollow profiled elements represented in FIG. 1 comprises a roof frame 1 with longitudinal and cross members 1a, 1b, as well as longitudinal members 2a, 2b arranged on both sides at the height of the vehicle floor. The longitudinal members 2a arranged centrally in the longitudinal direction of the vehicle are embodied as floor sills. The longitudinal members 2b extend from the front bumper as far as the rear closure of the carrier structure. In addition, the carrier structure comprises three pairs of posts in the form of hollow profiled elements, namely the B posts 3, the C posts 4, and the D posts 5, whereby the B and C posts 3, 4 connect the roof frame 1 to the longitudinal members 2a and the D posts 5 connect the roof frame 1 to the longitudinal members 2b.

As represented with the example of the B and D posts 3, 5, in FIGS. 3 to 7, the posts 3, 4, 5 are in each case embodied as double plates formed by high internal pressure and welded at their circumferential edges, whereby the circumferential edge forms flanges 3c, 5c for door seals and/or window seals. For preference the flanges 3c, 5c themselves accommodate a seal. This of course also applies to the circumferential edge of the C post 4, not represented in detail.

Represented in detail in FIG. 2 is a B post 3 of the carrier structure. By means of internal high pressure forming, the two plates of the double plate arrangement are formed to an inner shell 3a and an outer shell 3b with a common circumferential edge. For preference, the two shells 3a, 3b of the post 3 consist of different materials. In this situation, for example, the outer shell 3b of the B post 3, particularly subjected to load in the event of a crash, can be made from a high-strength steel. Likewise, one of the shells 3a, 3b, or even both, can in each case consist of a tailored blank. This allows for the structure to be strengthened in the particularly crash-sensitive regions, while in the less crash-relevant regions weight can be saved by lower wall thickness.

As represented in particular in FIG. 2b, the B post 3 exhibits a cross-section which changes over the length of the post 3. At its upper end, the B post 3 is splayed and cut to length, with the formation of an upper connection region 31. As represented in detail in FIGS. 3a and 3b, the B post 3 exhibits in its upper connection region 31, as a result of the cutting, two parallel upward-projecting flanges 31a, which, in order to connect the post to the roof frame 1, surround a longitudinal member 1a of the roof frame 1 (represented in sectional form) in a U-shape, and are connected to this by means of weld seams 31b. As a result, a very compact and adequately rigid connection node is formed between the B post and the roof frame 1.

As can be derived in particular from FIG. 2a, the B post 3 is splayed at its lower end with the formation of a further connection region 32 in one dimension. The connection of the B post 3 to a longitudinal member 2a of the carrier structure is represented in FIG. 4 a-c. According to this, the B post 3 is inserted with its lower connection region 32 into the longitudinal member 2a through an aperture 21a formed in its upper side. In order to guarantee a secure retention of the B post 3 in the longitudinal member 2a, this exhibits on both its side surfaces two beads 22a arranged above one another and running in the longitudinal direction of the longitudinal member 2a. The cups on the interior of the beads 22a located in pairs opposite one another, are in this situation arranged at a distance from one another in such a way that they are in contact free of play on both sides at the shells 3a, 3b of the inserted B post 3. At these contact points the B post 3 is connected securely by weld seams 32a to the floor sill 2a. In this situation, the weld seams 32a are for preference produced by through-welding of the longitudinal member 2a with laser beams.

By means of the type of connection described above of the B post 3 to the longitudinal member 2a, with which the inserted end of the B post in the longitudinal member 2a functions as a bulkhead plate, a highly rigid node structure is formed, by means of which the carrier structure offers a high degree of safety for the vehicle occupants in the event of a side crash.

FIG. 5 shows a D post 5 of the carrier structure. This likewise exhibits a cross-section which changes over the length of the post 3, and, like the B post 3 described heretofore, is splayed and cut to length at its upper end so as to form a connection region 51. As is represented in detail in FIG. 6, the D post 5 exhibits in the area of its upper connection region 51 on the outer shell 5b an upward-projecting flange 51a, as well as, on the inner shell 5a, a flange 51b, bent through 90° and pointing in the direction of the interior of the vehicle. Both flanges 51a, 51b surround the longitudinal member 1a of the roof frame 1, shown in sectional form, in L-shape, and are connected to it by weld seams 51c.

As represented in FIGS. 5 and 7, the lower end of the D post 5 is splayed, with the formation of a lower connection region 52, and partially cut to length. Specifically, the inner shell 5a of the D post 5 is cut back in relation to the outer shell 5b, so that the D post 5 encompasses with its lower connection region 52 the floor sill 2a in an L-shape. In order to form a rigid connection node, the D post 5 is securely connected to the longitudinal member 2a by means of weld seams 52a.

1. A carrier structure of a motor vehicle in a spaceframe style, comprising a roof frame provided with a longitudinal members and a cross members, and floor-side longitudinal members made of hollow profiled elements arranged at both sides at the level of the vehicle floor, and with posts in the form of hollow profiled elements, which connect the longitudinal members of the roof frame with the floor-side longitudinal members, whereby at least two opposing posts of the carrier structure, are formed from profiled elements formed under high internal pressure, and the respective ends of the posts are embodied as connection regions adapted to the shape of the floor-side longitudinal members and the longitudinal members of the roof frame for connection to the floor-side longitudinal members and the longitudinal members of the roof frame, wherein the posts are formed from double plates welded at their circumferential edges and bulged to hollow profiles by high internal pressure, of which the circumferential edges form flanges (3c, 5c) for door seals or window seals.

2. The carrier structure according to requirement claim 1, wherein the flanges take up a seal.

3. The carrier structure according to claim 1, wherein the double plates include a first plate and a second plate made of a different material than the first plate.

4. The carrier structure according to claim 1, wherein the double plates include a first plate and a second plate and at least one of the first and second plates is formed of a tailored blank.

5. The carrier structure according to claim 1, wherein the posts exhibit a cross-section which changes over their length.

6. The carrier structure according to claim 1, wherein at least one of the post ends is splayed.

7. The carrier structure according to claim 1, wherein at least one of the post ends is inserted into the floor-side longitudinal member or longitudinal member of the roof frame allocated to it, and is supported there on opposing side faces of a respective longitudinal member.

8. The carrier structure according to claim 1, wherein at least one of an end of the post is cut to length.

9. The carrier structure according to claim 8, wherein at least one cut post end is in contact at an outer side and at least one further side of the floor-side longitudinal member or longitudinal member of the roof frame allocated to it.

10. The carrier structure according to claim 9, wherein at least one cut post end surrounds the longitudinal member allocated to it in a U-shape.
